(19) United States
(12) Patent Application Publication
(10) Pub. No.: US 2023/0341685 A1
(43) Pub. Date: Oct. 26, 2023

(54) DUAL INPUT IMAGING LIGHT GUIDE

(71) Applicant: Vuzix Corporation, West Henrietta, NY (US)

(72) Inventor: Robert J. Schultz, Victor, NY (US)

(21) Appl. No.: 18/023,245

(22) PCT Filed: Aug. 24, 2021
(86) PCT No.: PCT/US2021/047377

§ 371 Date: Feb. 24, 2023

Related U.S. Application Data
(60) Provisional application No. 63/069,643, filed on Aug. 24, 2020.

(51) Int. Cl. G02B 27/01; G02B 6/26; G02B 6/34

(52) U.S. Cl. CPC G02B 27/0172; G02B 6/262; G02B 6/34; G02B 2027/0178; G02B 2027/0118; G02B 2027/0123

(57) ABSTRACT

An image light guide for conveying a virtual image includes a substrate operable to propagate image-bearing light beams. A first incoupling diffractive optic is formed along the substrate, and is operable to diffract a first portion of the image bearing light beams from an image source into the substrate in an angularly encoded form, as well as to transmit a second portion of the image-bearing light beams from the image source. An out-coupling diffractive optic formed along the substrate, wherein the out-coupling diffractive optic is operable to expand the image-bearing light beams and direct the expanded image-bearing light beams from the substrate in an angularly decoded form. A second in-coupling diffractive optic is formed along the substrate, and is operable to diffract a portion of the second portion of the image-bearing light beams into the substrate in an angularly encoded form.

### TECHNICAL FIELD

The present disclosure relates generally to electronic displays and more particularly to displays utilizing image light guides with diffractive optics to convey image-bearing light to a viewer.

### BACKGROUND

Head-Mounted Displays (HMDs) and virtual image near-eye displays are being developed for a range of diverse uses, including military, commercial, industrial, fire-fighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

Although conventional image light guide arrangements have provided significant reduction in bulk, weight, and overall cost of near-eye display optics, further improvements are needed. In some instances, size of the eyebox is constrained, forcing HMD designs to limit tolerances for movement and device placement. Light can often be unevenly distributed over the visual field, leading to hot spots, such as higher levels of light within the center of the field and lower light levels within the field periphery. Thus, in some arrangements the diffraction efficiencies of an image light guide are not great enough to produce the desired virtual image brightness. The virtual image that is generated by an image light guide arrangement should have sufficient brightness for satisfactory visibility and viewer comfort.

### SUMMARY

In a first exemplary embodiment, the present disclosure provides an image light guide for conveying a virtual image includes a substrate operable to propagate image-bearing light beams. A first in-coupling diffractive optic is formed along the substrate, wherein the in-coupling diffractive optic is operable to diffract a first portion of the image-bearing light beams from an image source into the substrate in an angularly encoded form, and wherein the first in-coupling diffractive optic is operable to transmit a second portion of the image-bearing light beams from the image source therethrough. An out-coupling diffractive optic is formed along the substrate, wherein the out-coupling diffractive optic is operable to expand the image-bearing light beams and direct the expanded image-bearing light beams from the substrate in an angularly decoded form. A second in-coupling diffractive optic is also formed along the substrate, wherein the second in-coupling diffractive optic is operable to diffract a portion of the second portion of the image-bearing light beams into the substrate in an angularly encoded form. The image light guide further includes an optical coupler located along an axis of the image source, wherein the optical coupler is operable to direct the second portion of image-bearing light from the image source onto the second in-coupling diffractive optic.

In a second exemplary embodiment, the present disclosure provides an image light guide system for conveying a virtual image, including an image source operable to project image-bearing light corresponding to a virtual image along a first axis, wherein pixels of the virtual image are infinity focused. The image light guide system also includes a first substrate operable to propagate image-bearing light and a second substrate operable to propagate image-bearing light, wherein the second substrate is coupled with the first substrate. Each of the first and second substrates includes a first in-coupling diffractive optic, a second in-coupling diffractive optic, and an out-coupling diffractive optic. The out-coupling diffractive optic is operable to expand the image-bearing light and direct the expanded image-bearing light from the substrate. The image light guide system further includes an optical coupler located along the first axis, wherein the optical coupler is located at least partially along a path of image-bearing light transmitted through the first in-coupling diffractive optics of said first and second substrates. The optical coupler is operable to direct the image-bearing light onto the second in-coupling diffractive optic of the second substrate, wherein the second in-coupling diffractive optic is operable to diffract a portion of the image-bearing light into the second substrate in an angularly encoded form and transmit a portion of the image-bearing light beams toward the second in-coupling diffractive optic of the first substrate, wherein the second in-coupling diffractive optic of the first substrate is operable to diffract a portion of the image-bearing light into the first substrate in an angularly encoded form.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 shows a simplified cross-sectional view of an image light guide showing the expansion of an image-bearing beam along the direction of propagation for expanding one direction of an eyebox.

FIG. 2 shows a perspective view of an image light guide with a turning grating showing the expansion of an image-bearing beam perpendicular to the direction of propagation for expanding a second direction of an eyebox.

FIG. 3 shows a schematic plan view of an image light guide having dual in-coupling diffractive optics according to an exemplary embodiment of the presently disclosed subject matter.

FIG. 4 shows a schematic side view of the image light guide according to FIG. 3 having an optical coupler according to an exemplary embodiment of the presently disclosed subject matter.

FIG. 5A shows a schematic end view of the image light guide according to FIG. 4 having two in-coupling diffractive optics located on a first surface.

FIG. 5B shows a schematic end view of the image light guide according to FIG. 4 having a first in-coupling diffractive optic located on a first surface and a second in-coupling diffractive optic located on a second surface.

FIG. 5C shows a schematic end view of the image light guide according to FIG. 4 having a first in-coupling diffractive optic located on a second surface and a second in-coupling diffractive optic located on a first surface.

FIG. 5D shows a schematic end view of the image light guide according to FIG. 4 having a first in-coupling diffractive optic located on a second surface and a second in-coupling diffractive optic located on the second surface.

FIG. 6 shows a schematic perspective view of the image light guide according to FIG. 4.

FIG. 7A shows a schematic perspective view of the optical coupler according to FIG. 4.

FIG. 7B shows a schematic end view of the optical coupler according to FIG. 4 wherein the first surface comprises a mirror.

FIG. 8A shows a schematic end view of an image light guide according to FIG. 4

FIG. 8B shows a schematic end view of an image light guide according to FIG. 8A having the planar waveguide rotated about an axis.

FIG. 9 shows a schematic top view of the optical coupler according to FIG. 4.

FIGS. 10A and 10B show a schematic of a portion of periodic diffraction gratings according to an exemplary embodiment of the presently disclosed subject matter.

FIG. 11 shows schematic end view of a stacked imaging light guide system according to an exemplary embodiment of the presently disclosed subject matter.

FIG. 12 shows a schematic side view of the stacked imaging light guide system according to FIG. 11.

FIG. 13 shows a display system for augmented reality viewing using imaging light guides according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where they are used herein, the terms “first”, “second”, and so on, do not necessarily denote any ordinal, sequential, or priority relation, but are simply used to more clearly distinguish one element or set of elements from another, unless specified otherwise.

Where they are used herein, the terms “viewer”, “operator”, “observer”, and “user” are considered equivalents and refer to the person/machine that views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where they are used herein, the terms “coupled,” “coupler,” or “coupling” in the context of optics refer to a connection by which light travels from one optical medium or device to another optical medium or device.

Where used herein, the terms “beam expansion,” “expansion of an image-bearing beam,” and “expanded image-bearing light” are intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or buried within the waveguide. Such diffractive optics can be formed as diffraction gratings, holographic optical elements (HOE's) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along one direction. In addition, a turning grating can be positioned on/in the waveguide to provide pupil expansion in an orthogonal direction. The image-bearing light output from the waveguide provides an expanded eyebox for the viewer.

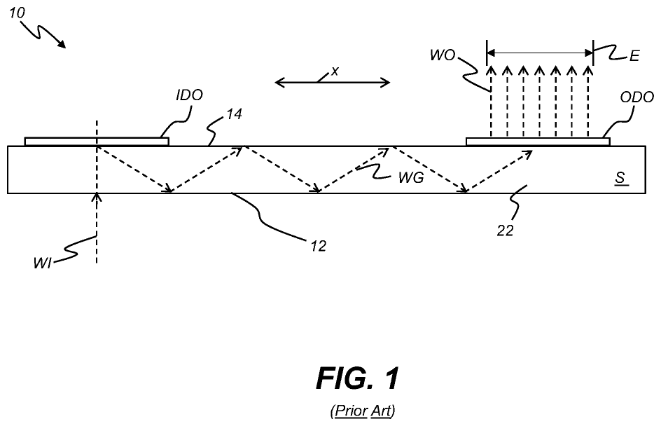

As illustrated in FIG. 1, an image light guide 10 may comprise a planar waveguide 22 having plane-parallel surfaces. The waveguide 22 comprises a transparent substrate S having an outer surface 12 and an inner surface 14 located opposite the outer surface 12. In this example, an in-coupling diffractive optic IDO and an out-coupling diffractive optic ODO are arranged on the inner surface 14 and the in-coupling diffractive optic IDO is a reflective type diffraction grating through which image-bearing light WI is coupled into the planar waveguide 22. However, the in-coupling diffractive optic IDO could alternately be a transmissive type diffraction grating, volume hologram or other holographic diffraction element, or other type of optical component that provides diffraction for the incoming, image-bearing light WI. The in-coupling diffractive optic IDO can be located on the outer surface 12 or the inner surface 14 of the planar waveguide 22 and can be of a transmissive or reflective type in a combination that depends upon the direction from which the image-bearing light WI approaches the planar waveguide 22.

When used as a part of a virtual display system, the in-coupling diffractive optic IDO couples the image-bearing light WI from an image source into the substrate S of the planar waveguide 22. Any real image or image dimension is first converted into an array of overlapping angularly related beams encoding the different positions within a virtual image for presentation to the in-coupling diffractive optic IDO. The image-bearing light WI is diffracted (generally through a first diffraction order) and thereby redirected by in-coupling diffractive optic IDO into the planar waveguide 22 as image-bearing light WG for further propagation along the planar waveguide 22 by Total Internal Reflection (“TIR”). Although diffracted into a generally more condensed range of angularly related beams in keeping with the boundaries set by TIR, the image-bearing light WG preserves the image information in an encoded form. The out-coupling diffractive optic ODO receives the encoded image-bearing light WG and diffracts (also generally through a first diffraction order) the image-bearing light WG out of the planar waveguide 22 as the image-bearing light WO toward the intended location of a viewer's eye. Generally, the out-coupling diffractive optic ODO is designed symmetrically with respect to the in-coupling diffractive optic IDO to restore the original angular relationships of the image-bearing light WI among outputted angularly related beams of the image-bearing light WO. However, to increase one dimension of overlap among the angularly related beams in a so-called eyebox E within which the virtual image can be seen, the out-coupling diffractive optic ODO is arranged to encounter the image-bearing light WG multiple times and to diffract only a portion of the image-bearing light WG on each encounter. The multiple encounters along the length of the out-coupling diffractive optic ODO in the direction of propagation have the effect of expanding one direction of the eyebox E within which the beams overlap. The expanded eyebox E decreases sensitivity to the position of a viewer's eye for viewing the virtual image.

In this example, the out-coupling diffractive optic ODO is a transmissive type diffraction grating arranged on the inner surface 14 of the planar waveguide 22. However, like the in-coupling diffractive optic IDO, the out-coupling diffractive optic ODO can be located on the outer surface 12 or the inner surface 14 of the planar waveguide 22 and be of a transmissive or reflective type in a combination that depends upon the direction through which the image-bearing light WG is intended to exit the planar waveguide 22.

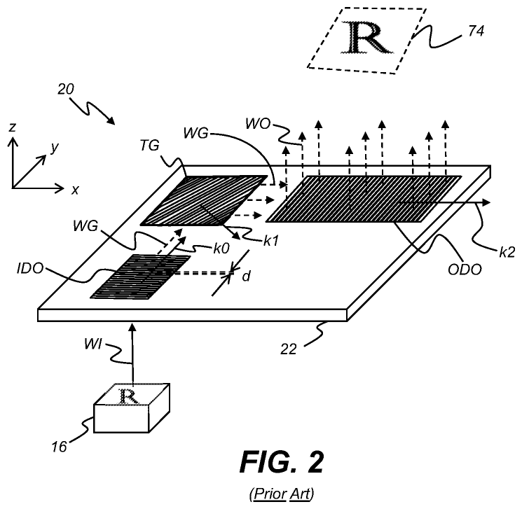

As illustrated in FIG. 2, an image light guide 20 may be arranged for expanding an eyebox 74 in two directions, i.e., along both x- and y-axes of the intended image. To achieve a second direction of beam expansion, the in-coupling diffractive optic IDO is oriented to diffract the image-bearing light WG about a grating vector k0 toward an intermediate turning grating TG whose grating vector k1 is oriented to diffract the image-bearing light WG in a reflective mode toward the out-coupling diffractive optic ODO. Only a portion of the image-bearing light WG is diffracted by each of multiple encounters with intermediate turning grating TG thereby laterally expanding each of the angularly related beams of the image-bearing light WG approaching the out-coupling diffractive optic ODO. The turning grating TG redirects the image-bearing light WG into an at least approximate alignment with a grating vector k2 of the out-coupling diffractive optic ODO for longitudinally expanding the angularly related beams of the image-bearing light WG in a second direction before exiting the planar waveguide 22 as the image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of the diffractive optics IDO, TG, ODO.

As illustrated in FIG. 2, the in-coupling diffractive optic IDO receives the incoming image-bearing light WI containing a set of angularly related beams corresponding to individual pixels or equivalent locations within an image generated by an image source 16. The image source 16, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. The image light guide 20 outputs an expanded set of angularly related beams in two directions by providing multiple encounters of the image-bearing light WG with both the intermediate turning grating TG and the out-coupling diffractive optic ODO in different orientations. In the original orientation of the planar waveguide 22, the intermediate grating TG provides beam expansion in the y-axis direction, and the out-coupling diffractive optic ODO provides a similar beam expansion in the x-axis direction. The reflectivity characteristics and respective periods d of the diffractive optics IDO, ODO, TG, together with the orientations of their respective grating vectors, provide for beam expansion in two directions while preserving the intended relationships among the angularly related beams of the image-bearing light WI that are output from the image light guide 20 as the image-bearing light WO.

While the image-bearing light WI input into the image light guide 20 is encoded into a different set of angularly related beams by the in-coupling diffractive optic IDO, the information required to reconstruct the image is preserved by accounting for the systematic effects of the in-coupling diffractive optic IDO. The turning grating TG, located in an intermediate position between the in-coupling and out-coupling diffractive optics IDO, ODO, is typically arranged so that it does not induce any significant change on the encoding of the image-bearing light WG. The out-coupling diffractive optic ODO is typically arranged in a symmetric fashion with respect to the in-coupling diffractive optic IDO, e.g., including diffractive features sharing the same period. Similarly, the period of the turning grating TG also typically matches the common period of the in-coupling and out-coupling diffractive optics IDO, ODO. As illustrated in FIG. 2, the grating vector k1 of the turning grating TG may be oriented at 45 degrees with respect to the other grating vectors k0, k2 (all as undirected line segments). However, in an embodiment, the grating vector k1 of the turning grating TG is oriented at 60 degrees to the grating vectors k0, k2 of the in-coupling and out-coupling diffractive optics IDO, ODO in such a way that the image-bearing light WG is turned 120 degrees. By orienting the grating vector k1 of the intermediate turning grating TG at 60 degrees with respect to the grating vectors k0, k2 of the in-coupling and out-coupling diffractive optics IDO, ODO, the grating vectors k0, k2 are also oriented at 60 degrees with respect to each other (again considered as undirected line segments). Basing the grating vector magnitudes on the common pitch of the turning grating TG and the in-coupling and out-coupling diffractive optics IDO, ODO, the three grating vectors k0, k1, k2 (as directed line segments) form an equilateral triangle, and sum to a zero-vector magnitude, which avoids asymmetric effects that could introduce unwanted aberrations including chromatic dispersion.

The image-bearing light WI that is diffracted into the planar waveguide 22 is effectively encoded by the in-coupling diffractive optic IDO, whether the in-coupling diffractive optic IDO uses gratings, holograms, prisms, mirrors, or some other mechanism. Any reflection, refraction, and/or diffraction of light that takes place at the in-coupling diffractive optic IDO must be correspondingly decoded by the out-coupling diffractive optic ODO to re-form the virtual image that is presented to the viewer. The turning grating TG, placed at an intermediate position between the in-coupling and out-coupling diffractive optics IDO, ODO, is typically designed and oriented so that it does not induce any change on the encoded light. The out-coupling diffractive optic ODO decodes the image-bearing light WG into its original or desired form of angularly related beams that have been expanded to fill the eyebox 74.

Whether any symmetries are maintained or not among the turning grating TG and the in-coupling and out-coupling diffractive optics IDO, ODO or whether any change to the encoding of the angularly related beams of the image-bearing light WI takes place along the planar waveguide 22, the turning grating TG and the in-coupling and out-coupling diffractive optics IDO, ODO are related so that the image-bearing light WO that is output from the planar waveguide 22 preserves or otherwise maintains the original or desired form of the image-bearing light WI for producing the intended virtual image.

The letter “R” represents the orientation of the virtual image that is visible to the viewer whose eye is in the eyebox 74. As shown, the orientation of the letter “R” in the represented virtual image matches the orientation of the letter “R” as encoded by the image-bearing light WI. A change in the rotation about the z axis or angular orientation of incoming image-bearing light WI with respect to the x-y plane causes a corresponding symmetric change in rotation or angular orientation of outgoing light from out-coupling diffractive optic ODO. From the aspect of image orientation, the turning grating TG simply acts as a type of optical relay, providing expansion of the angularly encoded beams of the image-bearing light WG along one axis (e.g., along the y-axis) of the image. The out-coupling diffractive optic ODO further expands the angularly encoded beams of the image-bearing light WG along another axis (e.g., along the x-axis) of the image while maintaining the original orientation of the virtual image encoded by the image-bearing light WI. As illustrated in FIG. 2, the turning grating TG may be a slanted or square grating arranged on the front or back surfaces of the planar waveguide 22. Alternately, the turning grating TG may be a blazed grating.

The present disclosure provides for an image light guide arrangement having improved image-bearing light output intensity across the output aperture. More specifically, the present disclosure provides for, inter alia, a waveguide having more than one in-coupling diffractive optic and an out-coupling diffractive optic operable to expand image-bearing light beams in two-directions and output the expanded image-bearing light beams toward an eyebox.

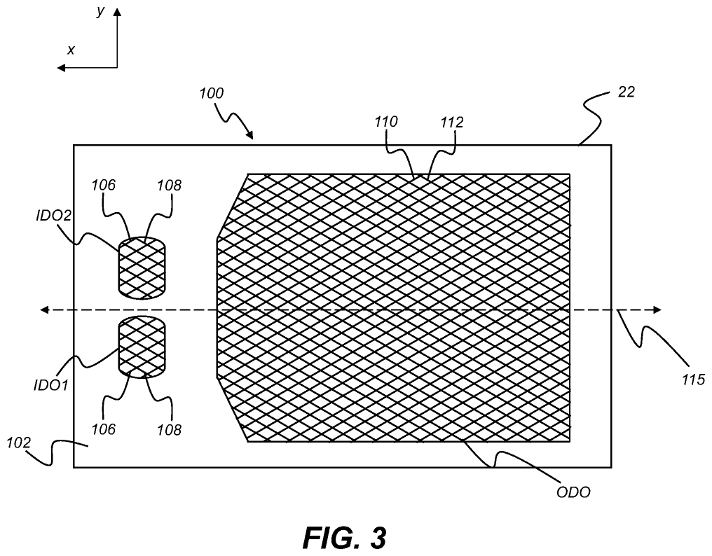

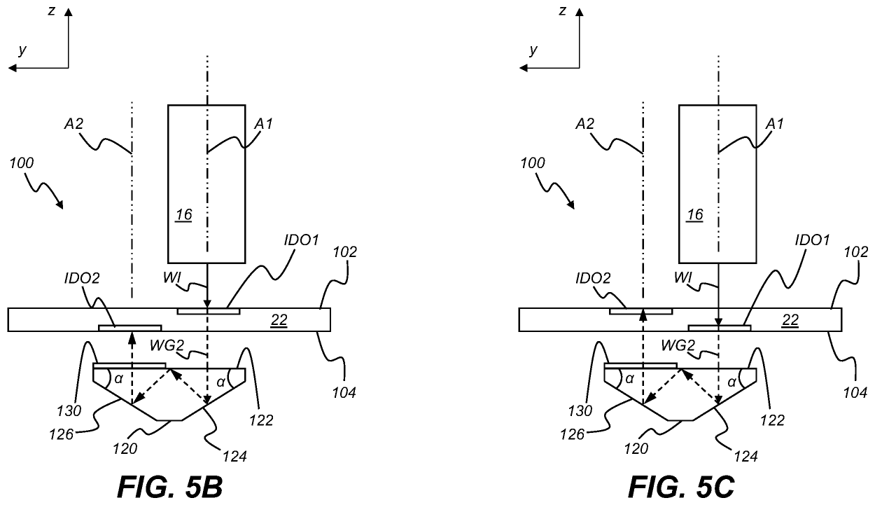

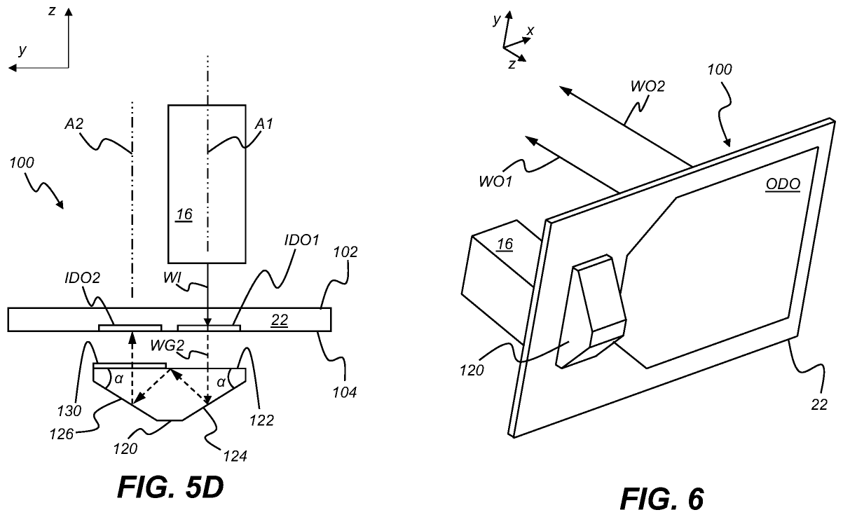

As illustrated in FIGS. 3, 4, and 5A, an image light guide 100 may have a first in-coupling diffractive optic IDO1, a second in-coupling diffractive optic IDO2, and an out-coupling diffractive optic ODO formed on/in a first surface 102 of the planar waveguide 22. In another embodiment, as illustrated in FIG. 5B, the first in-coupling diffractive optic IDO1 and the out-coupling diffractive optic ODO are formed on/in the first surface 102 of the planar waveguide 22, and the second in-coupling diffractive optic IDO2 is formed on/in the second surface 104 of the planar waveguide 22 located opposite the first surface 102. In another embodiment, as illustrated in FIG. 5C, the first in-coupling diffractive optic IDO1 is formed on/in the second surface 104 of the planar waveguide 22, and the second in-coupling diffractive optic IDO2 and the out-coupling diffractive optic ODO are located on/in the first surface 102 of the planar waveguide 22. In another embodiment, as illustrated in FIG. 5D, the first and second in-coupling diffractive optics IDO1, IDO2 are formed on/in the second surface 104 of the planar waveguide 22, and the out-coupling diffractive optic ODO is located on/in the first surface 102 of the planar waveguide 22. In yet another embodiment, the first and second in-coupling diffractive optics IDO1, IDO2 and the out-coupling diffractive optic ODO are formed on/in the second surface 104 of the planar waveguide 22.

Referring now to FIG. 3, in an embodiment, the first and second in-coupling diffractive optics IDO1, IDO2 comprise two pluralities of periodic grating structures 106, 108. For example, the in-coupling diffractive optic IDO may comprise a first set of periodic linear grating structures 106 rotated/offset relative to the x-axis by an angle less than thirty degrees (e.g., 25°), and a second set of periodic linear grating structures 108 rotated/offset relative to the x-axis by an angle less than negative thirty degrees (e.g., −25°). The first and second sets of periodic grating structures 106, 108 are crossed. The first set of periodic grating structures 106 comprises a first period, and the second set of periodic grating structures 108 comprise a second period. In an embodiment, the second period is equal to the first period.

In an embodiment, the out-coupling diffractive optic ODO comprises third and fourth sets of periodic grating structures 110, 112. The third and fourth sets of periodic grating structures 110, 112 are parallel with the first and second sets of periodic grating structures 106, 108, respectively. The third and fourth sets of periodic grating structures 110, 112 form a compound diffractive optic operable to expand and out-couple image-bearing light from the in-coupling diffractive optics IDO1, IDO2. In an embodiment, the third set of periodic grating structures 110 is crossed with the fourth set of periodic grating structures 112. The third and fourth sets of periodic grating structures 110, 112 may also have the same periodicity as the first and second sets of periodic grating structures 106, 108, respectively. In an embodiment, the out-coupling diffractive optic ODO has bilateral symmetry across a longitudinal axis 115.

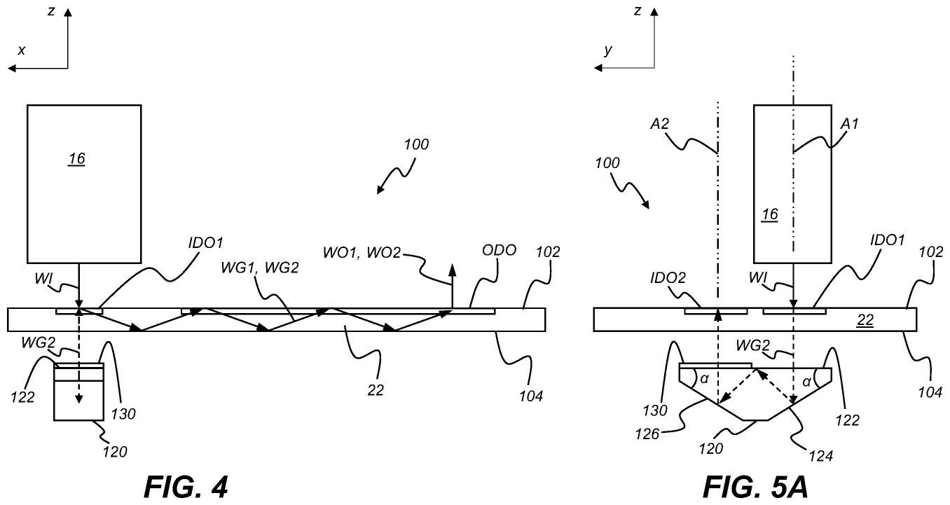

As illustrated in FIGS. 4-7B, in an embodiment, the image light guide 100 includes an optical coupler 120. The optical coupler 120 is located adjacent to the in-coupling diffractive optics IDO1, IDO2 on an opposite side of the planar waveguide 22 from a projector 16 (i.e., image source). In an embodiment, the optical coupler 120 includes a first surface 122 located generally proximal to the planar waveguide 22. The optical coupler 120 also includes a second surface 124 disposed at an angle α relative to the first surface 122, and a bilaterally symmetric third surface 126 disposed at an angle α relative to the first surface 122. In an embodiment, the optical coupler 120 is assembled from two right angle prisms 120A, 120B. In an embodiment, the second and third surfaces 124, 126 are mirrored surfaces.

The first surface 122 is the incident face of the optical coupler 120 and receives image-bearing light from the projector 16 along a first axis A1. The first axis A1 is aligned with a center ray of the projector 16. The image-bearing light reflects from the second surface 124 back toward the first surface 122 within the TIR angle range. The first surface 122 is operable to reflect the image-bearing light under TIR, and the image-bearing light reflected from the second surface 124 is reflected by the first surface 122 toward the third surface 126. The third surface 126 further reflects the image-bearing light toward the first surface 122 within an angle range operable to transmit through the first surface 122. The image-bearing light is output from the optical coupler 120 centered along a second axis A2. The second axis A2 is aligned with a center ray output from the optical coupler 120. The second axis A2 is offset from the first axis A1 along the y-axis direction. Designing the optical coupler 120 to have three points of reflection within the optical coupler 120 prevents the virtual image of the image-bearing light incident upon the optical coupler 120 from being flipped.

In operation, image-bearing light WI from the projector 16 is incident upon the first in-coupling diffractive optic IDO1, a first portion of the image-bearing light WG1 is diffracted by the first in-coupling diffractive optic IDO1 and generally propagates toward the out-coupling diffractive optic ODO via TIR. A second portion of the image-bearing light WI transmits through the first in-coupling diffractive optic IDO1 and the planar waveguide 22 and is incident upon the optical coupler 120. The second portion of the image-bearing light WI transmits through the first surface 122 of the optical coupler 120 and reflects from the second surface 124 of the optical coupler at an angle of incidence operable to reflect from the first surface 122 via TIR. The second portion of the image-bearing light WI is then reflected from the first surface 122 under TIR and is incident upon the third surface 126 of the optical coupler where the second portion of the image-bearing light WI is reflected back toward the first surface 122 and transmitted therethrough along the second axis A2.

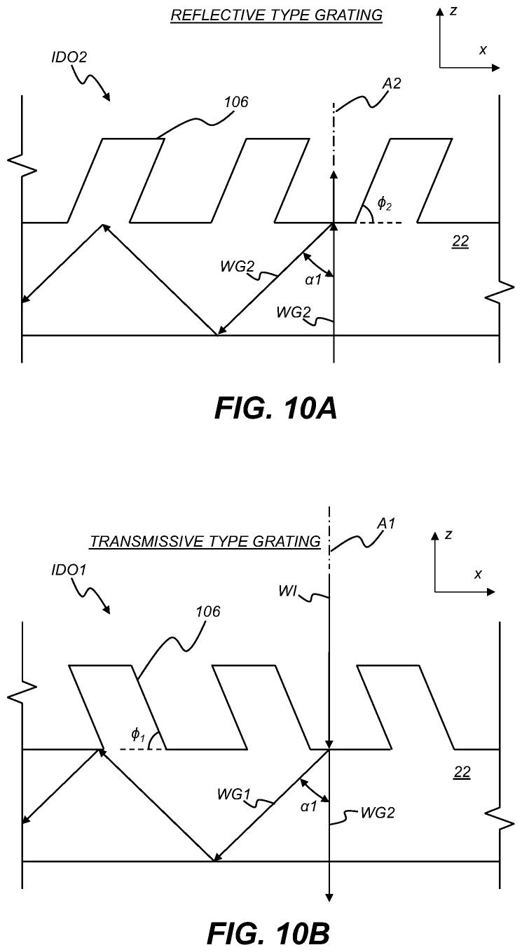

The second portion of the image-bearing light WI centered along the second axis A2 is then incident upon the second in-coupling diffractive optic IDO2. A portion of the second portion of the image-bearing light WG2 is diffracted by the second in-coupling diffractive optic IDO2 and generally propagates toward the out-coupling diffractive optic ODO via TIR. In an embodiment, the second in-coupling diffractive optic IDO2 is configured to optimize diffractive efficiency for image-bearing light output from the optical coupler 120. For example, the first in-coupling diffractive optic IDO1 may be configured as a transmissive type diffraction grating and the second in-coupling diffractive optic IDO2 may be configured as a reflective type diffraction grating. As illustrated in FIGS. 10A and 10B, where the first and second sets of periodic grating structures 106, 108 are surface-relief gratings, the first and second sets of periodic grating structures 106, 108 are slanted at a slant angle 4 relative to a plane parallel with the first and second surfaces 102, 104 of the planar waveguide 22. In an embodiment, the first set of periodic grating structures 106 of the first in-coupling diffractive optic IDO1 may have a slant angle ϕ₁ and the first set of periodic grating structures 106 of the second in-coupling diffractive optic IDO2 may have a slant angle ϕ₂. Similarly, the second set of periodic grating structures 108 of the first in-coupling diffractive optic IDO1 may have a slant angle 41 and the second set of periodic grating structures 108 of the second in-coupling diffractive optic IDO2 may have a slant angle ϕ₂. The periodic grating structures 106, 108 of the first and second in-coupling diffractive optics IDO1, IDO2 may have slant angles ϕ that are rotated one-hundred-eighty degrees relative to each other.

By utilizing the optical coupler 120 and the second in-coupling diffractive optic IDO2, the imaging light guide 100 is operable to in-couple a greater percentage of the image-bearing light from the projector 16. Increasing the percentage of the image-bearing light from the projector 16 which is in-coupled to the planar waveguide 22 increases the brightness of the virtual image viewed in an eyebox.

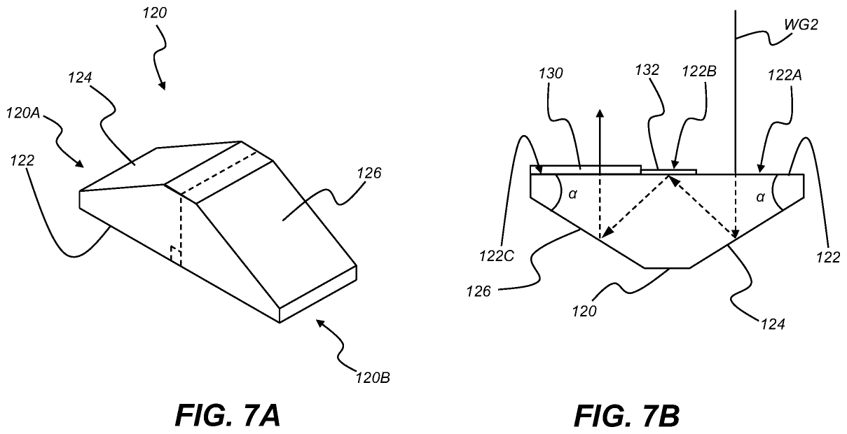

In an embodiment, as illustrated in FIG. 7B, the first surface 122 of the optical coupler 120 may include a mirrored surface 132. The mirrored surface 132 may be formed on the first surface 122 such that the second portion of image-bearing light reflected from the second surface 124 is incident upon the mirrored surface 132. The mirrored surface 132 may be formed by applying an at least partially reflective coating to a portion of the optical coupler first surface 122. Image-bearing light from the image source 16 that is incident upon a first portion 122A of the optical coupler first surface 122 is transmitted therethrough and is incident upon the second surface 124. Image-bearing light reflected from the second surface 124 is incident upon a second portion 122B of the first surface 122 having the mirrored surface 132 and is reflected toward the third surface 126. Image-bearing light reflected from the second portion 122B of the first surface 122 is incident upon the third surface 126 and is reflected toward a third portion 122C of the first surface 122. Image-bearing light incident upon the third portion 122C of the first surface 122 is transmitted therethrough.

In an embodiment, as illustrated in FIGS. 4, 5A-D, and 7B, the imaging light guide 100 may include a waveplate 130 located between the optical coupler 120 and the planar waveguide 22. The length of the waveplate 130 is less than the length of the optical coupler 120, such that light transmitted through the planar waveguide 22 and incident upon the first surface 122 of the optical coupler 120 does not transmit through the waveplate 130, while image-bearing light reflected from the third surface 126 and transmitted through the first surface 122 of the optical coupler 120 is transmitted through the waveplate 130. The waveplate 130 is operable to turn the polarization direction of the image-bearing light such that the imaging light guide 100 takes full advantage of the image-bearing light from the projector 16. For example, the waveplate 130 may be a half-wave waveplate operable to turn the polarization direction of the image-bearing light orthogonal (90°) or nearly orthogonal. In an embodiment, the waveplate 130 may be a quarter-wave waveplate operable to turn the polarization direction of the image-bearing light generally forty-five degrees (45°). Transmissive type diffraction gratings have lower polarization sensitivity than reflective type diffraction gratings. Where the second in-coupling diffractive optic IDO2 is a reflective type diffraction grating, polarization of the image-bearing light via the half-wave waveplate 130 enables a greater diffraction efficiency. In other words, in an embodiment, there is more image-bearing light from the image source 16 available to be in-coupled into the waveguide 22 via the second in-coupling diffractive optic IDO2 in an alternate polarization. In an embodiment, the projector 16 comprises a digital light processing (“DLP”) projector operable to output unpolarized light.

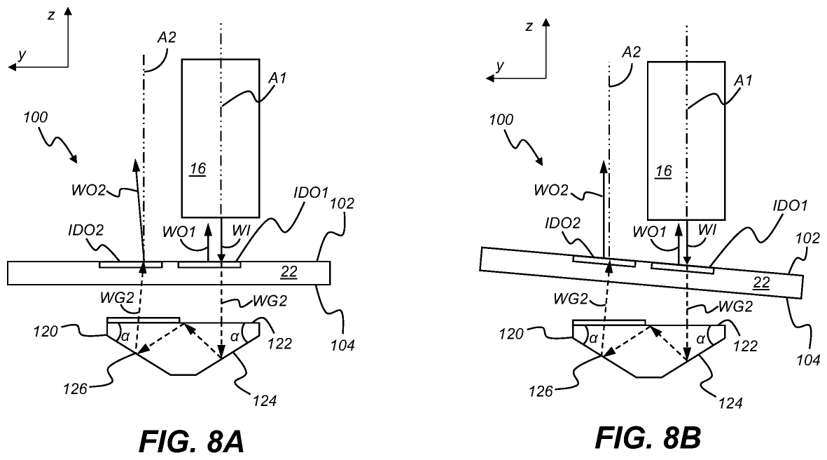

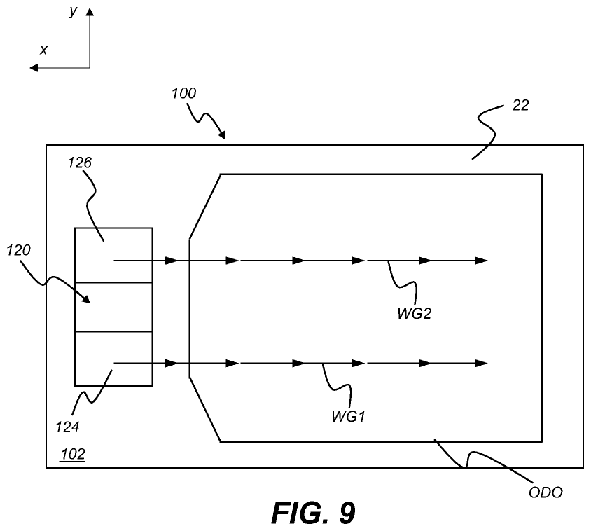

In an embodiment, as illustrated in FIG. 8A, where there are imperfections in the manufacturing of the optical coupler 120 and/or there are errors in the alignment of the projector 16 and the optical coupler 120, the image light guide 100 may produce two misaligned virtual images. For example, as shown in FIG. 8A, an imperfection in the optical coupler 120 may cause the image-bearing light WG2 to be incident upon the second in-coupling diffractive optic IDO2 at an angle relative to the second axis A2; this angle of incidence is mirrored in angle of the second out-going light beam WO2 relative to the second axis A2 causing misalignment of the two virtual images. As illustrated in FIG. 8B, the planar waveguide 22 may be rotated, or rocked, about the x-axis and/or the y-axis to align the two virtual images produced by the image light guide 100. Rotating the planar waveguide 22 relative to the projector 16 and the optical coupler 120 compensates for the effect of the imperfections in alignment of the center ray of an image-bearing light beam WG2 in-coupled into the planar waveguide 22 via the second in-coupling diffractive optic IDO2 and out-coupled via the out-coupling diffractive optic ODO. Rotating the planar waveguide 22 about the center of the first in-coupling diffractive optic IDO1 allows the second out-going light beam WO2 to be repositioned relative to the second in-coupling diffractive optic IDO2, without changing the center ray position of the first out-going light beam WO1 relative to the center of the first diffractive optic IDO1. As shown in FIGS. 8A and 8B, rocking the planar waveguide 22 aligns the central ray of image-bearing light beams WO1, WO2 generally parallel with respect to one another. This feature allows for a greater tolerance in the alignment of the projector 16 and the optical coupler 120. In other words, the projector 16 and the optical coupler 120 do not have to be aligned with extreme accuracy because the waveguide 22 may be utilized for alignment of the virtual images.

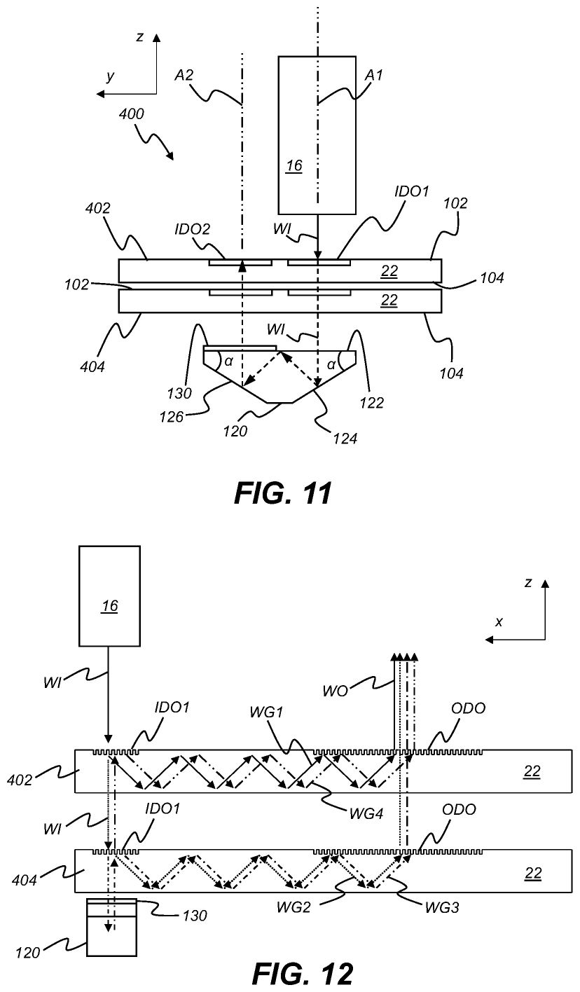

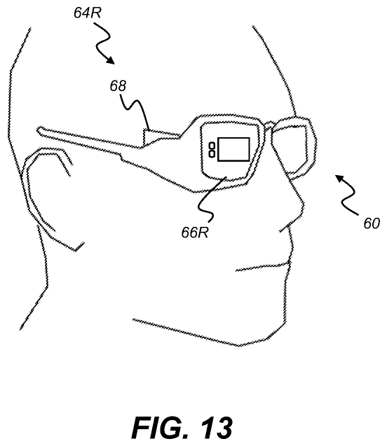

As illustrated in FIGS. 11 and 12, in an embodiment, a stacked image light guide assembly 400 includes a first image light guide 402 coupled with a second image light guide light guide 404. At least one of the first image light guide 402 and the second image light guide 404 is one of the image light guides 100 described supra. The image light guides 402, 404 are formed on separate waveguide substrates 22 that are mechanically coupled. In an embodiment, the waveguide substrates 22 of the image light guides 402, 404 are mechanically coupled via an adhesive. In another embodiment, the waveguide substrates 22 are held in position relative to one another by structural means of the HMD. For example, where the HMD incorporating the image light guides 402, 404 is smart glasses (see FIG. 13), the waveguide substrates 22 may be held in relative position via the glasses rims. In an embodiment, the stacked image light guide assembly 400 provides three separate color channels. A first portion of the image-bearing light WI from the projector 16 that is incident upon the first in-coupling diffractive optic IDO1 of the first image light guide 402 is diffracted and propagates toward the out-coupling diffractive optic ODO of the first image light guide 402 via TIR.

A second portion of the image-bearing light WI that is incident upon the first-in-coupling diffractive optic of the first image light guide 402 is transmitted therethrough and is incident upon the first in-coupling diffractive optic IDO1 of the second image light guide 404. A portion of the image-bearing light WG2 that is incident upon the first in-coupling diffractive optic IDO1 of the second image light guide 404 is diffracted and propagates toward the out-coupling diffractive optic ODO of the second image light guide 404 via TIR. A third portion of the image-bearing light WI is transmitted through the in-coupling diffractive optic IDO1 of the second image light guide 404 and is incident on the optical coupler 120 as described above. The third portion of the image-bearing light WI is then output from the optical coupler 120 centered along the second axis A2 and is incident upon the second in-coupling diffractive optic IDO2 of the second image light guide 404. A portion of the image-bearing light WG3 that is incident upon the second in-coupling diffractive optic IDO2 of the second image light guide 404 is diffracted and propagates toward the out-coupling diffractive optic ODO of the second image light guide 404 via TIR. A fourth portion of the image-bearing light WI is transmitted through the second in-coupling diffractive optic IDO2 of the second image light guide 404 and is incident on the second in-coupling diffractive optic IDO2 of the first image light guide 402. A portion of the image-bearing light WG4 that is incident upon the second in-coupling diffractive optic IDO2 of the first image light guide 402 is diffracted and propagates toward the out-coupling diffractive optic ODO of the first image light guide 402 via TIR. The image-bearing light WG1, WG2, WG3, WG4 that is incident upon the out-coupling diffractive optics ODO of the first and second image light guides 402, 404 is expanded and out-coupled toward an eyebox as image-bearing light WO.

The perspective view of FIG. 13 shows a display system 60 for augmented reality viewing using one or more image light guides of the present disclosure. Display system 60 is shown as an HMD with a right-eye optical system 64R having an image light guide 66R for the right eye. The display system 60 includes an image source 68, such as a picoprojector or similar device, energizable to generate an image. In an embodiment, the display system 60 includes a left-eye optical system including one or more image light guides and a second image source. The images that are generated can be a stereoscopic pair of images for 3-D viewing. The virtual image that is formed by the display system 60 can appear to be superimposed or overlaid onto the real-world scene content seen by the viewer through an image light guide 66R. Additional components familiar to those skilled in the augmented reality visualization arts, such as one or more cameras mounted on the frame of the HMD for viewing scene content or viewer gaze tracking, can also be provided.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. An image light guide for conveying a virtual image, comprising:
a substrate operable to propagate image-bearing light beams;
a first in-coupling diffractive optic formed along said substrate, wherein said in-coupling diffractive optic is operable to diffract a first portion of said image-bearing light beams from an image source into said substrate in an angularly encoded form, and wherein said in-coupling diffractive optic is operable to transmit a second portion of said image-bearing light beams from said image source;
an out-coupling diffractive optic formed along said substrate, wherein said out-coupling diffractive optic is operable to expand an eyebox in at least one direction and direct said image-bearing light beams from said substrate in an angularly decoded form;
a second in-coupling diffractive optic formed along said substrate, wherein said second in-coupling diffractive optic is operable to diffract a portion of said second portion of said image-bearing light beams into said substrate in an angularly encoded form; and
an optical coupler located along an axis of said image source, wherein said optical coupler is operable to direct said second portion of image-bearing light beams said second in-coupling diffractive optic.

2. The image light guide for conveying a virtual image according to claim 1, wherein said first in-coupling diffractive optic is operable to diffract image-bearing light beams incident thereon from a first direction at a greater efficiency than said second in-coupling diffractive optic, and wherein said second in-coupling diffractive optic is operable to diffract image-bearing light beams incident thereon from a second direction at a greater efficiency than said first in-coupling diffractive optic.

3. The image light guide for conveying a virtual image according to claim 1, wherein said first in-coupling diffractive optic is operable as a transmissive type diffractive optic and said second in-coupling diffractive optic is operable as a reflective type diffractive optic.

4. The image light guide for conveying a virtual image according to claim 3, wherein said first in-coupling diffractive optic and said second in-coupling diffractive optic comprise surface relief gratings.

5. The image light guide for conveying a virtual image according to claim 1, wherein said substrate comprises first and second opposing surfaces, and wherein said first in-coupling diffractive optic and said second in-coupling diffractive optic are located in said first surface, or wherein said first in-coupling diffractive optic is located in said first surface and said second in-coupling diffractive optic is located in said second surface.

6. (canceled)

7. The image light guide for conveying a virtual image according to claim 2, wherein said first in-coupling diffractive optic and said second in-coupling diffractive optic comprise slanted surface relief grating features, and wherein said grating features of said second in-coupling diffractive optic are slanted substantially one-hundred-eighty degrees relative to said grating features of said first in-coupling diffractive optic.

8. The image light guide for conveying a virtual image according to claim 2, wherein said first in-coupling diffractive optic and said second in-coupling diffractive optic comprise blazed surface relief grating features, and wherein said grating features of said second in-coupling diffractive optic are symmetric to said grating features of said first in-coupling diffractive optic.

9. The image light guide for conveying a virtual image according to claim 1, wherein said optical coupler comprises:
a first surface operable to transmit said image-bearing light beams incident thereon at a first angle relative to said first surface and operable to reflect said image-bearing light beams incident thereon at a second angle relative to said first surface;
a second surface operable to reflect said image-bearing light beams; and
a third surface operable to reflect said image-bearing light beams.

10. The image light guide for conveying a virtual image according to claim 9, wherein said second surface of said optical coupler is symmetric with said third surface of said optical coupler.

11. The image light guide for conveying a virtual image according to claim 9, wherein said image-bearing light beams reflected by said second surface and incident upon said first surface reflect from said first surface via total internal reflection.

12. The image light guide for conveying a virtual image according to claim 9, wherein said image-bearing light beams reflected by said third surface and incident upon said first surface are transmitted through said first surface.

13. The image light guide for conveying a virtual image according to claim 9, wherein said image-bearing light beams exit said optical coupler laterally offset from where said image-bearing light beams enter said optical coupler.

14. The image light guide for conveying a virtual image according to claim 9, wherein said image-bearing light beams follow a path within said optical coupler comprising three reflections, and wherein said image-bearing light beams exit said optical coupler at a mirror angle relative to said input image-bearing light beams.

15. The image light guide for conveying a virtual image according to claim 9, wherein said optical coupler comprises two right-angle prisms.

16. (canceled)

17. The image light guide for conveying a virtual image according to claim 1, further comprising a waveplate located between said optical coupler and said second in-coupling diffractive optic, wherein said waveplate is operable to rotate a polarization of said image-bearing light beams, wherein said waveplate comprises a half-wave waveplate or a quarter-wave waveplate.

18. (canceled)

19. (canceled)

20. The image light guide for conveying a virtual image according to claim 1, wherein:
said first portion of said image-bearing light beams in-coupled via said first in-coupling diffractive optic correspond to a first virtual image,
said second portion of said image-bearing light beams in-coupled via said second in-coupling diffractive optic correspond to a second virtual image,
wherein said first and second virtual images are substantially identical,
wherein said substrate is rotated such that a surface of said substrate is positioned at an angle relative to said optical coupler first surface, whereby said first and second virtual images are aligned at an infinity focus.

21. The image light guide for conveying a virtual image according to claim 1, wherein said optical coupler comprises:
a first surface operable to transmit said image-bearing light beams incident thereon at a first portion of said first surface and operable to reflect said image-bearing light beams incident thereon at a second portion of said first surface, wherein said second portion of said first surface is a mirrored surface;
a second surface operable to reflect said image-bearing light beams; and
a third surface operable to reflect said image-bearing light beams;
wherein said image-bearing light beams reflected by said second surface and incident upon said second portion of said first surface reflect from said first surface and are incident upon said third surface,
wherein said image-bearing light beams reflected by said third surface and incident upon said first surface is are transmitted therethrough.

22. An image light guide system for conveying a virtual image, comprising:
an image source operable to project image-bearing light beams corresponding to a virtual image along a first axis, wherein pixels of said virtual image are infinity focused;
a first substrate operable to propagate said image-bearing light beams;
a second substrate operable to propagate said image-bearing light beams, wherein said second substrate is coupled with said first substrate;
wherein each of said first and second substrates, comprise:
a first in-coupling diffractive optic,
a second in-coupling diffractive optic; and
an out-coupling diffractive optic, wherein said out-coupling diffractive optic is operable to expand an eyebox in at least one direction and direct at least a portion of said image-bearing light beams from said substrate in an angularly decoded form;
an optical coupler located along said first axis, wherein said optical coupler is located at least partially along a path of said image-bearing light beams transmitted through said first in-coupling diffractive optics of said first and second substrates, wherein said optical coupler is operable to direct said image-bearing light beams to said second in-coupling diffractive optic of said second substrate, wherein said second in-coupling diffractive optic is operable to diffract a portion of said image-bearing light beams into said second substrate in an angularly encoded form and transmit a portion of said image-bearing light beams toward said second in-coupling diffractive optic of said first substrate, and wherein said second in-coupling diffractive optic of said first substrate is operable to diffract a portion of said image-bearing light beams into said first substrate in an angularly encoded form.

23. The image light guide for conveying a virtual image according to claim 22, wherein said first in-coupling diffractive optic is operable as a transmissive type diffractive optic and said second in-coupling diffractive optic is operable as a reflective type diffractive optic.

24. The image light guide for conveying a virtual image according to claim 22, wherein said optical coupler comprises:
a first surface operable to transmit said image-bearing light beams incident thereon at a first angle relative to said first surface and operable to reflect said image-bearing light beams incident thereon at a second angle relative to said first surface;
a second surface operable to reflect said image-bearing light beams; and
a third surface operable to reflect said image-bearing light beams.
